(19) United States
(12) Patent Application Publication
(10) Pub. No.: US 2014/0057224 A1
(43) Pub. Date: Feb. 27, 2014

(54) SURGICAL GUIDING DEVICE

(71) Applicant: Taiwan Implant Technology Company, Kaohsiung City (TW)

(72) Inventors: Ching-Chien HUANG, Kaohsiung City (TW); Ying-lung Cheng, Kaohsiung City (TW); Hsiao-ching Wang, Kaohsiung City (TW); Yi-nung Ho, Kaohsiung City (TW)

(73) Assignee: Taiwan Implant Technology Company, Kaohsiung City (TW)

(21) Appl. No.: 13/904,037

(22) Filed: May 29, 2013

(30) Foreign Application Priority Data
Aug. 23, 2012 (TW) 101216285

(51) Int. Cl. A61C 1/08

(52) U.S. Cl. CPC A61C 1/084
USPC 433/75

(57) ABSTRACT

A surgical guiding device comprises: an elongate portion comprising a handpiece connection port and a shank connection port, wherein sizes of the handpiece connection port and the shank connection port comply with the ISO1797 standard; a height controlling portion being a hollow cylinder with two end openings, and having a first end portion and a second end portion; and a retaining portion disposed on an outer surface of the height controlling portion to adjust an installation height of the height controlling portion in relation to a surgical positioning device. The present invention comply with the ISO1797 standard and it is not necessary to persistently exchange the different sizes of movable sleeves to simply the implanting process, so as to shorten the time of the surgery and reduce the consumption of the cost. Therefore, the present invention also can reduce the discomfort and pain of the patient in treating process.

This application claims the priority of Taiwan Utility Model Patent Publication No. M442134, filed on Dec. 1, 2012, entitled “Surgical Guiding Device” completed by CHING-CHIEH HUANG, YING-LUNG CHENG, HSIAO-CHING WANG and YI-HUNG HO.

### FIELD OF THE INVENTION

The present invention relates to a surgical guiding apparatus field, and more particularly to a surgical guiding device complying with the ISO1797 standard and suitably applied to various dental drills.

### BACKGROUND OF THE INVENTION

Recently, due to the increasing popularization of a computerized tomography (CT) scanning technology, the dentist firstly operates a computer to simulate the density of the bone and the distribution of nerves and blood vessels in the alveolar bone, and simultaneously calculates the size of a predefined implant and the parameters of the position, angle and depth thereof based on tooth occlusion relationship. Furthermore, a dental drill is then used to cooperate with a movable sleeve for a drilling surgery, so as to reduce the risk and of complications the surgery. Therefore, it is advantageous to improve the result of whole treatment, so that the satisfaction of the patient is increased.

However, due to the different actual status of the oral cavities of different patients, the dentist has to exchange various tooth drills in different surgical stages, if necessary. In the traditional surgery, to ensure drilling along the same central axis each time, each of dental drills with different specific sizes needs to cooperate with a movable sleeve, wherein the outer diameter of the movable sleeve is equal to a sleeve and the inner diameter of the movable sleeve is equal to the outer diameter of the dental drill. Therefore, there is a problem existing in the management of various surgical devices. Furthermore, due to incompatibility of various manufacturers' systems, surgical devices of different manufacturers are not matched with each other. When any mistakes occurred in operating process, confusion and errors are easily happened to significantly affect the quality of the surgery.

Additionally, in the surgical process of the traditional techniques, it is still necessary to pay attention to the calibration indication through an assistant device to avoid from excessively drilling. However, once excessively drilling, it can not be remedied, so that it is difficult to have prevention effect. On the other hand, the dentist may carefully drill a first drilled hole which does not achieve the predefined depth at the first time. Therefore, the dentist has to operate drilling again, and it easily causes to enlarge or deviate the diameter of the first drilled hole.

As a result, it is necessary to provide a surgical guiding device to solve the problems existing in the traditional technologies, as described above.

### SUMMARY OF THE INVENTION

A primary object of the present invention is to provide a surgical guiding device, which complies with the ISO1797 standard and can be applied to various handpieces and dental drills of different implant manufacturers. And, it is unnecessary to persistently exchange traditional movable sleeves according to the order of expanding a hole, so as to increase the accuracy of the implanting surgery.

Another object of the present invention is to provide a surgical guiding device, which adjusts an installation height of a height controlling portion in relation to a surgical positioning device, and a shank connection port rotatably abuts against a first end portion of the height controlling portion, so as to limit a drilling depth of the dental drill, so that it is unnecessary to control the drilling depth by using extra device.

A further another object of the present invention is to provide a surgical guiding device, which is unnecessary to hand-hold a movable sleeve to avoid from shaking in surgical process, so as to increase the flexibility and convenience to the dentist in surgery.

To achieve the above object, the present invention provides a surgical guiding device which comprises:

an elongate portion comprising a handpiece connection port and a shank connection port, wherein sizes of the handpiece connection port and the shank connection port comply with the ISO1797 standard;

a height controlling portion being a hollow cylinder with two end openings, and having a first end portion and a second end portion; and

a retaining portion disposed on an outer surface of the height controlling portion to adjust an installation height of the height controlling portion in relation to a surgical positioning device.

In one embodiment of the present invention, the handpiece connection port is used to connect a dental implanting machine and the shank connection port is used to insert a dental drill, and the dental drill passes through the height controlling portion and the surgical positioning device for drilling teeth.

In one embodiment of the present invention, the shank connection port rotatably abuts against the first end portion of the height controlling portion, so as to limit a drilling depth of the dental drill.

In one embodiment of the present invention, the dental drill is rotatably and loosely fitted in the first end portion.

In one embodiment of the present invention, the inner diameter of the first end portion is equal to 2.35 mm, and the inner diameter of the second port is greater than a maximum outer diameter of the dental drill.

In one embodiment of the present invention, the outer diameter of the height controlling portion is equal to the inner diameter of an installation hole of the surgical positioning device.

In one embodiment of the present invention, the outer diameter of the retaining portion is greater than the inner diameter of an installation hole of the surgical positioning device.

In one embodiment of the present invention, the surgical positioning device is a sleeve or a template.

In one embodiment of the present invention, the retaining portion is adjustably mounted on one of steps of an outer surface of the first end portion of the height controlling portion in clipping engagement or screw-connection manner for adjusting the drilling depth of the dental drill.

In one embodiment of the present invention, the interval of the two adjacent steps is between 0.5 mm and 2 mm.

In comparison with the traditional techniques, the present invention complies with the ISO1797 standard, and meets specifications of various dental drills and handpiece machines of different manufacturers in the market. It not only reduces the time of preparing surgical devices before surgery to optimize a working process, but also can accompany with a self-designed surgical positioning device according to clinical needs, so as to develop corresponding surgical apparatus sets of human factors engineering, so that it is convenient to operate by the dentist. The present invention provides an universal standard design, while it is unnecessary to persistently exchange movable sleeves of different sizes. Thus, the implanting process can be simplified, the time of the surgery can be shortened, and the consumption of the cost can be reduced. On the other hand, the present invention also can reduce the discomfort and pain of the patient in treating process, so as to decrease the risk of the surgery. Furthermore, when the dental drill is inserted into the shank connection port and passes through the height controlling portion and the surgical positioning device for drilling a tooth, the shank connection port rotatably abuts against the first end portion of the height controlling portion to further limit a drilling depth of the dental drill.

In regard to the feature and implementation of the present invention, preferred embodiment is in concert with figures to describe in detail hereinafter:

### DESCRIPTION OF THE DRAWINGS

FIG. 1 is a schematic view of a surgical guiding device according to a preferred embodiment of the present invention; and

FIG. 2 is a schematic view of the surgical guiding device accompanied with a surgical positioning device according to the preferred embodiment of the present invention.

### DETAILED DESCRIPTION OF THE PREFERRED EMBODIMENTS

The structure and the technical means adopted by the present invention to achieve the above and other objects can be best understood by referring to the following detailed description of the preferred embodiments and the accompanying drawings. Furthermore, directional terms described by the present invention, such as upper, lower, front, back, left, right, inner, outer, side, longitudinal/vertical, transverse/horizontal, and etc., are only directions by referring to the accompanying drawings, and thus the used directional terms are used to describe and understand the present invention, but the present invention is not limited thereto.

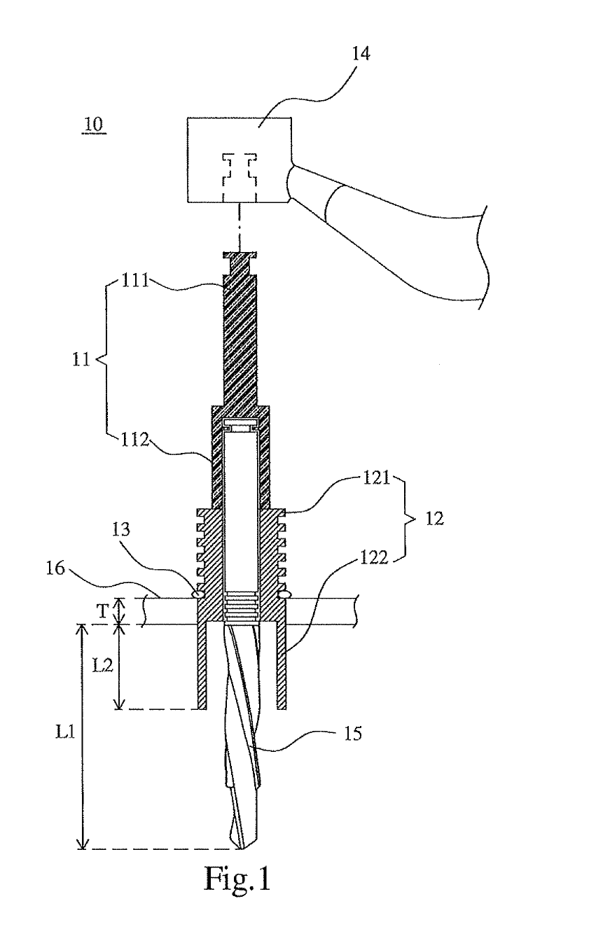

Referring now to FIG. 1, a surgical guiding device 10 according to a preferred embodiment of the present invention is illustrated. As shown, the surgical guiding device 10 comprises: an elongate portion 11, a height controlling portion 12 and a retaining portion 13. The elongate portion 11 comprises a handpiece connection port 111 and a shank connection port 112. The height controlling portion 12 is a hollow cylinder with two end openings, and has a first end portion 121 and a second end portion 122. The retaining portion 13 is disposed on an outer surface of the first end portion 121 of the height controlling portion 12, wherein sizes of the handpiece connection port 111 and the shank connection port 112 comply with the ISO1797 standard.

Referring back to FIG. 1, a schematic view of a surgical guiding device according to the preferred embodiment of the present invention is illustrated, wherein the handpiece connection port 111 is used to connect a dental implanting machine 14 and the shank connection port 112 is used to insert a dental drill 15. In surgical process of the traditional implanting technology, the dentist has to exchange different dental drill 15 according to the status of the oral cavity or the expending order of the patient, such as a drill having a round bur for breaking surficial cortical bone, a pilot drill having downward-jagged and lateral-jagged cutting edges or a depth drill used to deeply drill an implanted hole to a predefined depth. Furthermore, the dentist also needs to exchange various movable sleeves corresponding to different sizes of the dental drills. The sizes of the handpiece connection port 111 and the shank connection port 112 comply with ISO1797 standard, so that the dentist can easily connect it to an implanting machine 14 and a dental drill 15 manufactured by different manufacturers in the market. Therefore, the present invention can simplify the process of implanting to improve surgical operation.

In one embodiment of the present invention, the shank connection port 112 can rotate over the first end portion 121 or rotatably abut against the first end portion 121 of the height controlling portion 12, so as to limit the handpiece connection port 111 and the dental drill 15. Because the inner diameter of the first end portion 121 is equal to 2.35 mm (standard 02.35 mm), and the inner diameter of the shank connection port 112 is also equal to 2.35 mm with a certain amount of fitted spans. Therefore, the dental drill 15 is rotatably and loosely fitted in the first end portion 121. Through a surgical positioning device 16 installed on a dental mold, the dentist can exactly align axial lines of the shank connection port 112 and the dental drill 15 with an axial line of the first end portion 121 of the height controlling port 12. When the axial line of the positioning device 16 is aligned to a pathway of drilling hole, a central line of the dental drill 15 is also aligned to the drilled hole, so as to avoid the dental drill 15 from deviating. Furthermore, the inner diameter of the second end portion 122 is greater than the maximum outer diameter of the dental drills 15 used in implanting process. The dentist can detach or attach a dental drill 15 of suitable size from/to the shank connection port 112 according to the drilling order of the drilled hole.

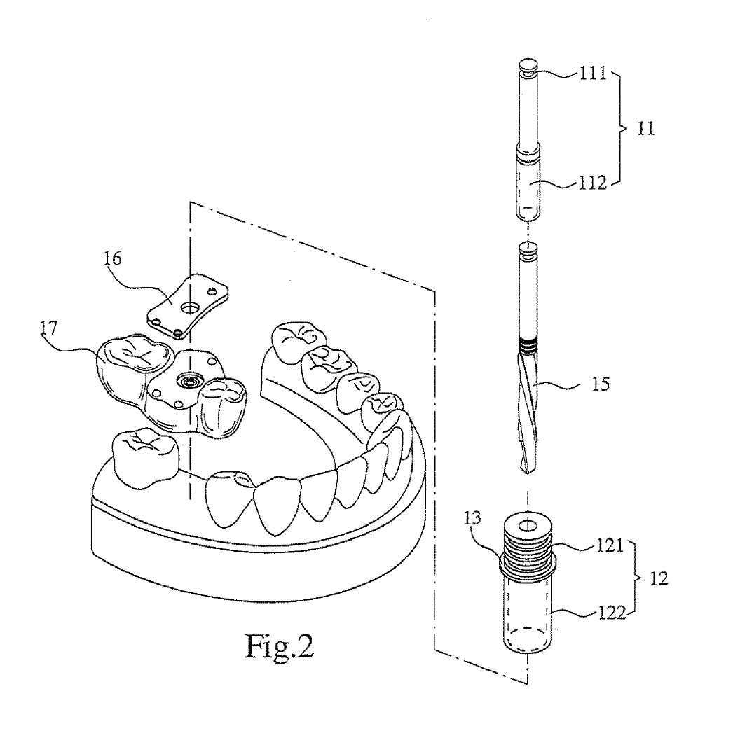

Referring to FIG. 2, a schematic view of the surgical guiding device accompanied with a surgical positioning device according to the preferred embodiment of the present invention is illustrated, wherein the outer diameter of the height controlling portion 12 is equal to the inner diameter of an installation hole of a surgical positioning device 16. Such a combination is not necessary to hand-hold a movable sleeve to avoid from shaking in surgical process, so as to increase the flexibility and convenience in surgical process to the dentist. Additionally, the surgical guiding device 10 limited by the surgical positioning device 16 is operated by the dentist to align a drilling position along a guiding hole of the surgical positioning device 16, so as to ensure the predefined drilling depth to avoid from excessively drilling. in the embodiment, the guiding hole of the surgical positioning device 16 is vertical to the top surface of the surgical positioning device 16, and selectively vertical or tilted to the bottom surface of the surgical positioning device 16. When the surgical positioning device 16 is disposed on a dental mold 17, the surgical guiding device 10 can be vertical to the surgical positioning device 16, so that the dental drill 15 can be used to drill with a tilted angle. It is worth noted that an inner diameter of the surgical positioning device 16 also can be a sleeve having an inner diameter equal to that of the shank connection port 112 or a combination of the sleeve and a template.

In one embodiment of the present invention, the outer diameter of the retaining portion 13 is greater than the inner diameter of the surgical positioning device 16 to prevent the height controlling portion 12 from sliding downward, so as to avoid from excessively drilling. The retaining portion 13 is adjustably mounted on one of steps of an outer surface of the first end portion 121 of the height controlling portion 12 in clipping engagement or screw-connection manner, so as to allow adjusting the depth of the drill hole, but not limited thereto. The interval of the two adjacent steps, which the retaining portion 13 can move, is between 0.5 mm and 2 mm. Each interval of the two adjacent steps is preferably 0.5 mm, 1 mm or 2 mm. It is advantageous to control the drilling depth, and effectively and effortlessly drill to the predefined depth. Meanwhile, through exchanging a longer dental drill 15 or adjusting the position of the retaining portion 13, the dental drill 15 can reach the predefined depth. Additionally, if the position of the edentulous has a position with a poor viewing angle in oral cavity, it still can easily drill to the predefined depth, for example, according to the know thickness (T) of the surgical positioning device 16 and a length (L1) of a drillable region of the dental drill 15, the retaining portion 13 is adjusted to acquire a partial length (L2) that the second end port 122 of the height controlling portion 12 moves downward, so that the dentist can easily know the depth of the drilled hole. That is, L1-L2 is the depth of the drilled hole. Therefore, it is not necessary to pay attention to the calibration on the dental drill by naked eyes in surgical process.

When the dental drill 15 inserts into the shank connection port 112 and passes through the height controlling portion 12 and the surgical positioning device 16 for drilling, the shank connection port 112 rotatably abuts against the first end portion 121 at the final drilling stage, so as to limit a drilling depth of the dental drill 15.

As described above, the traditional surgical guiding devices has different specifications unmatched with each other to cause an inconvenience to the dentist and nurses and also bring a certain influence for surgery. Simultaneously, it is also disadvantages to the management of operating rooms. In contrast, the present invention of FIG. 1 has a single universal specification which complies with ISO1797 standard, and can be applied to various dental drills and handpieces of different manufacturers in the market. It not only can reduce the time of preparing surgical devices before surgery and optimize the working process, but also can accompany with a self-designed surgical positioning device in response to the clinical needs. Thus, the present invention provides a universal standard design, while it is not necessary to persistently exchange movable sleeves of different sizes. As a result, the implanting process can be simplified, the time of the surgery can be shortened, and the consumption of the cost can be reduced. On the other hand, the present invention also can reduce the discomfort and pain of the patient in treating process, so as to decrease the risk of the surgery.

The present invention has been described with a preferred embodiment thereof and it is understood that many changes and modifications to the described embodiment can be carried out without departing from the scope and the spirit of the invention that is intended to be limited only by the appended claims.

What is claimed is:

1. A surgical guiding device, comprising:
an elongate portion comprising a handpiece connection port and a shank connection port, wherein sizes of the handpiece connection port and the shank connection port comply with the ISO1797 standard;
a height controlling portion being a hollow cylinder with two end openings, and having a first end portion and a second end portion; and
a retaining portion disposed on an outer surface of the height controlling portion to adjust an installation height of the height controlling portion in relation to a surgical positioning device.

2. The surgical guiding device according to claim 1, wherein the handpiece connection port is used to connect a dental implanting machine and the shank connection port is used to insert a dental drill, and the dental drill passes through the height controlling portion and the surgical positioning device for drilling teeth.

3. The surgical guiding device according to claim 2, wherein the shank connection port rotatably abuts against the first end portion of the height controlling portion, so as to limit a drilling depth of the dental drill.

4. The surgical guiding device according to claim 3, wherein the dental drill is rotatably and loosely fitted in the first end portion.

5. The surgical guiding device according to claim 2, wherein the inner diameter of the first end portion is equal to 2.35 mm, and the inner diameter of the second port is greater than a maximum outer diameter of the dental drill.

6. The surgical guiding device according to claim 1, wherein the outer diameter of the height controlling portion is equal to the inner diameter of an installation hole of the surgical positioning device.

7. The surgical guiding device according to claim 6, wherein the outer diameter of the retaining portion is greater than the inner diameter of an installation hole of the surgical positioning device,

8. The surgical guiding device according to claim 1, wherein the surgical positioning device is a sleeve or a template.

9. The surgical guiding device according to claim 1, wherein the retaining portion is adjustably mounted on one of steps of an outer surface of the first end portion of the height controlling portion in dipping engagement or screw-connection manner.

10. The surgical guiding device according to claim 9, wherein the interval of the two adjacent steps is between 0.5 mm and 2 mm.
